(19) United States
(12) Patent Application Publication
(10) Pub. No.: US 2010/0021303 A1
(43) Pub. Date: Jan. 28, 2010

(54) Wind Turbine Comprising One Or More Oscillation Dampers

(76) Inventors: Thomas Steiniche Bjertrup Nielsen, Randers SV (DK); Jakob Hjorth Jensen, Spjald (DK)

Correspondence Address: ST. ONGE STEWARD JOHNSTON & REENS, LLC, 986 BEDFORD STREET, STAMFORD, CT, 06905-5619, US

(21) Appl. No.: 12/570,743

(22) Filed: Sep. 30, 2009

Related U.S. Application Data
(63) Continuation of application No. PCT/DK2008/000123, filed on Mar. 28, 2008.

(30) Foreign Application Priority Data
Mar. 30, 2007 (DK) PA 2007 00502

(51) Int. Cl. F03D 11/00

(52) U.S. Cl. 416/145

(57) ABSTRACT

A wind turbine includes one or more oscillation dampers, each damper having one or more closed cavities arranged within a blade of the wind turbine and containing a large number of solid elements that are arranged to move freely within the cavities.

### CROSS-REFERENCE TO RELATED APPLICATIONS

The present application is a continuation of pending International patent application PCT/DK2008/000123 filed on Mar. 28, 2008, which designates the United States and claims priority from Danish patent application PA 2007 00502 filed on Mar. 30, 2007, the content of which is incorporated herein by reference.

### FIELD OF THE INVENTION

The present invention relates to a wind turbine comprising one or more oscillation dampers, each damper comprising one or more closed cavities with a movable content and designed to dampen oscillations of the wind turbine.

### BACKGROUND OF THE INVENTION

With the increasing size of modern wind turbines, oscillations of various parts of the wind turbine have become a steadily more pronounced problem in the design and operation of wind turbines.

Oscillations and vibrations of the wind turbine, in particular of the wind turbine blades, are undesirable in that they may cause dangerously high loads, which may lead to fatigue damage, lifetime reduction or even a total collapse of one or more parts of the wind turbine in severe cases. In particular, oscillations along the cord between the trailing edge and the leading edge of a wind turbine blade, so-called edgewise oscillations, can damage the blades, which have little structural damping towards this kind of oscillations.

Both stall and pitch controlled wind turbines are in risk of being damaged by edgewise oscillations. The stall controlled turbines are mostly seeing this problem when operating in high winds beyond the stall point, whereas the pitch regulated turbines are mostly seeing the problem when idling or parked in high wind speeds.

To reduce the oscillations of wind turbine blades, it is known to provide the blades with different forms of mechanical dampers, most often based on the principle of a spring mounted mass combined with a damping device, or they can be provided with different kinds of liquid dampers. An example of a liquid damper is disclosed in Danish Utility Model No. DK 95 00222 U. This damper is very general in its construction in that it is not tuned to any specific frequency and it works in three dimensions, although it can be made more or less directional depending on the design of the liquid-containing cavities.

Another example is disclosed in International Patent Application No. WO 99/32789 where the tip end of a wind turbine blade is provided with a tuned liquid damper system. A liquid flows freely in a number of transversely positioned cavities placed as close to the tip of the blade as possible. The cavities have a specific length, which is adapted to the natural edgewise frequency of first order of the specific blade type. Even though this kind of frequency specific dampers weighs less than traditional multi-frequency dampers, they still have the disadvantage of adding considerable weight to the tip of the blade which is the position where added weight causes the largest additional load to the blade. For a frequency-tuned damper system, the typical natural oscillation frequencies of wind turbine blades, being only a few Hz, correspond to rather large cavity lengths, which could never be fitted into the tips of the blades. However, the centrifugal force due to the rotation of the rotor causes the speed of the damped liquid waves inside the cavities to increase, thereby enabling the damper to work properly with cavities of shorter lengths, suitable to be built into wind turbine blades with conventional dimensions. This, however, means that the damper is not very efficient at typical natural oscillation frequencies, when the wind turbine is parked with no rotation of the rotor.

As modern wind turbines become larger in output as well as in size, the length and the size of the blades also increase. As the blades become bigger and heavier, their natural edgewise frequencies become lower—down to a few Hz or even below 1 Hz—and the blades therefore become easier to excite by the wind. As the natural edgewise frequency gets lower, the mass and, thereby, also the size of a mechanical damper, a liquid damper or a tuned liquid damper has to be increased if the damping effect should be maintained at the same level as for smaller wind turbines.

As the width of the blade decreases towards the tip and the dampers get longer and wider, the space inside the blade near the tip becomes too small to contain the dampers. Thus, the dampers have to be moved further away from the tip, and the further from the tip it is moved, the bigger and heavier it has to be to give the same damping effect. This is of cause disadvantageous in that the heavier the blades are, the more load is induced to other components of the wind turbine. This requires stronger components which most often are more expensive.

U.S. Pat. No. 6,626,642 discloses a U-shaped liquid damper that may be tuned to damp edgewise oscillations of either the first or the second order of a wind turbine blade. By shaping the damper this way, the inventor overcomes some of the problem of producing an efficient damper that is sufficiently compact and flat in order to satisfy the severe spatial restrictions within the blade. However, the problem of low damping efficiency at the natural frequencies when the wind turbine is parked still exists.

An object of the invention is to provide a wind turbine comprising one or more oscillation dampers without the mentioned disadvantages, meaning that physically they are sufficiently small to be installed at narrow spaces within the wind turbine and that they are capable of damping efficiently at typical natural frequencies of first and/or second order.

A further object of the invention is to provide a wind turbine comprising one or more oscillation dampers sufficiently small for being arranged near the tips of the wind turbine blades, which dampers are capable of damping oscillations efficiently at typical natural frequencies of the blades of first and/or second order also when the rotor is not rotating or idling.

### SUMMARY OF THE INVENTION

The present invention relates to a wind turbine comprising one or more oscillation dampers, each damper comprising one or more closed cavities arranged within a blade of the wind turbine and containing a large number of solid elements that are arranged to move freely within the cavities.

It is advantageous if the large number of solid elements contained by each damper cavity are substantially spherical. Having this shape, the solid elements can easily move around in the cavity between each other without packing together.

In a preferred embodiment of the invention, each damper cavity contains a number of solid elements higher than 1000, preferably higher than 10000, so that the oscillating mass behaves like a continuous volume moving similar to a Bingham fluid and not a few elements sliding from one side of the cavity to another which would give a different damping response to the oscillations to be damped.

The use of solid elements in oscillation dampers is not unknown in the art.

In one embodiment of the above-mentioned U.S. Pat. No. 6,626,642, the invention comprises a single cylindrical element, whose motion is controlled by a toothed wheel engaged with a toothed rim. Other embodiments of this invention comprise a pendulum.

Also, International Patent Application No. WO 03/062637, discloses a wind turbine blade with a damping device comprising a single moving body that follows a path controlled by the design and shape of the damper cavity.

The above-mentioned Danish Utility Model No. DK 95 00222 U discloses a wind turbine blade with oscillation damping means comprising cavities containing an elastic, porous, granular or viscous substance, preferably a liquid and/or a granulate. The damper may contain a metal ball in a cavity filled completely with liquid. In this case, the purpose of the liquid is not to oscillate along with the solid mass but, on the contrary, to prevent the solid mass from moving freely by providing resistance against its motion.

Compared to dampers known in the art containing only liquid and/or one or very few solid elements, the present invention comprises a number of advantages.

First and foremost, the use of a large number of solid elements, preferably with a density higher than 3000 kg/m³, in replacement of a liquid makes it possible to increase the density of the oscillating mass within the damper cavities. Having densities of the oscillating mass significantly higher than the densities of the liquids typically used in cavities of the liquid dampers as are known from the art, enables the dampers of the present invention to provide a significantly larger damping effect per unit volume. In other words, a damping effect similar to or better than the ones provided by the known liquid dampers can be achieved by physically smaller dampers according to the present invention, which dampers can therefore be arranged closer to the tip of a wind turbine blade yielding an even better damping effect for oscillations of first order.

Secondly, the dampers of the present invention show an almost uniform damping efficiency across a relatively large range of oscillation amplitudes, contrary to liquid dampers whose damping efficiency decreases significantly with increasing oscillation amplitude, as shown in FIG. 4.

Thirdly, the dampers of the present invention are less frequency specific than the liquid dampers known from the art, meaning that it is less critical for the primary damper frequency to correspond exactly to the frequency of the wind turbine oscillation to be damped.

Moreover, the liquids used in the known tuned liquid dampers, such as potassium-iodide solutions, are usually very corrosive.

In a preferred embodiment of the present invention, the solid elements are made from a hard metal such as steel.

Using hard metal balls is advantageous for at least two reasons. Firstly, hard metal is not sensible to wear and plastic deformation when sliding forth and back within the damper cavity and colliding with the cavity boundaries. Thus, hard metal balls are likely to keep their spherical form throughout the lifetime of the oscillation damper. Secondly, the relatively high density of metal makes it possible to construct dampers that are physically relatively small even though they contain a sufficiently large oscillating mass to provide the necessary damping effect.

Preferably, the damper cavities contain a liquid as well as the solid elements.

It is well-known from the use of box-shaped tuned liquid dampers that, for a given oscillation frequency, the damping efficiency (measured in terms of logarithmic decrement of the oscillation) is largest for small oscillation amplitudes and decreases with increasing amplitudes. Experiments have shown that for dampers containing only steel balls, the opposite situation is the case: The damping efficiency generally increases with increasing oscillation amplitude at a given oscillation frequency. Furthermore, experiments show that using a proper mixture of liquid and spherical solid elements, an almost uniform damping effect can be achieved for a broad range of oscillation amplitudes at a given oscillation frequency, as illustrated in FIG. 4.

The liquid used in the damper cavities along with the elements can preferably be an oil.

Using a lubricant as the liquid inside the damper cavities facilitates the motion of the oscillating solid elements in the short term because of the immediate lubricating effect and in the long term because corrosion of the solid elements is avoided. It is evident that it is important to use an oil which is not sensitive to temperature changes and will keep its normal viscous properties over a large temperature range, such as from −40° C. to 60° C., for a very long time, such as 20 years.

Another advantage of dampers according to the present invention is that they can be produced at lower costs than the known liquid dampers because the liquids normally used in the latter are rather expensive compared to steel balls and oil.

The volume of the liquid inside a damper cavity can advantageously be chosen to be between 5% and 50%, preferably between 10% and 40%, most preferred between 25% and 35%, of the total volume of the solid elements inside the same damper cavity.

Experiments have shown, that with a ratio between the volume of the liquid and the volume of spherical solid elements within this range, an almost uniform damping effect can be achieved for a broad range of oscillation amplitudes at a given oscillation frequency.

One or more of the oscillation dampers of the present invention can be designed and arranged in a wind turbine blade for damping oscillations of the first natural bending frequency of the blade in the edgewise direction which for most modern wind turbines falls within the interval between 0.6 Hz and 1.8 Hz, preferably between 0.8 Hz and 1.6 Hz, most preferred between 1.0 Hz and 1.5 Hz.

Edgewise oscillations can cause of structural and mechanical damages to wind turbine blades, especially when the wind turbine is stopped with the rotor locked in a fixed position. Therefore, damping of this kind of oscillations is very important in order to avoid dangerous situations and shortening of the lifetime of the wind turbine blades.

Also, one or more of the oscillation dampers can be designed and arranged in a wind turbine blade for damping oscillations of the first natural bending frequency of the blade in the flapwise direction which for most modern wind turbines falls within the interval between 0.5 Hz and 1.4 Hz, preferably between 0.6 Hz and 1.2 Hz, most preferred between 0.7 Hz and 1.0 Hz.

The dampers disclosed in the invention are especially well-suited for damping of frequencies of the first order, because they can be made physically small and, therefore, can be arranged close to the tip of a wind turbine blade where the effect of the dampers on first order oscillations is higher than closer to the root of the blade.

Furthermore, one or more of the oscillation dampers can be designed and arranged in a wind turbine blade for damping oscillations of the second natural bending frequency of the blade in the edgewise direction which for most modern wind turbines falls within the interval between 2.5 Hz and 5.0 Hz, preferably between 3.0 Hz and 4.5 Hz, most preferred between 3.2 Hz and 4.2 Hz.

It is also possible that one or more of the oscillation dampers are designed and arranged in a wind turbine blade for damping oscillations of the second natural bending frequency of the blade in the flapwise direction which for most modern wind turbines falls within the interval between 1.5 Hz and 4.0 Hz, preferably between 1.8 Hz and 3.5 Hz, most preferred between 2.1 Hz and 3.1 Hz.

The fact that the dampers disclosed in the invention are well-suited for damping of first order oscillations does not in any way prevent them from being designed and arranged to be used for damping second order oscillations as well. Also, they can be used during operation as well as during standstill of the wind turbine.

Generally, the damping effect of the dampers disclosed in the present invention equates to a logarithmic decrement of oscillation amplitudes of at least 1%, preferably at least 2%, most preferred at least 4-6%, at the frequency to which the dampers are designed to have maximum damping efficiency.

The logarithmic decrement δ of the amplitude is defined as

$$δ = \frac{1}{n - 1} \cdot ln ( \frac{{a}_{1}}{{a}_{n}} ) \cdot 100 \%$$

where n is the number of oscillations, a₁ is the amplitude of the first oscillation, and aₙ is the amplitude of the nth oscillation.

The logarithmic decrements referred to above are preferably measured with oscillation amplitudes between 10 cm and 50 cm at the position of the damper.

When used for damping first order oscillations of a wind turbine blade, the damper cavities must be arranged as close to the tip of the blade as possible, such as in the outer half, preferably in the outer third, most preferred in the outer fourth, of the blade as measured from the centre of the hub towards the tip of the blade.

In an embodiment of the invention, one or more of the oscillation dampers are arranged in a winglet mounted at the tip of a wind turbine blade, whereby the achieved damping effect of the given dampers will be at its absolute maximum when it comes to first order oscillations whose amplitudes are largest at the tip of the blade.

In order to avoid packing of the solid elements which could cause the all to move together as one stiff element, it is advantageous that they are close to being perfectly spherical with the maximum cross-sectional length of a given solid element no more than 10% larger than the minimum cross-sectional length of said element.

Also, in order to prevent packing of the elements, it is advantageous that substantially all of them are of equal size.

It has been found that a good damping effect can be achieved if the average cross-sectional length of each of equally-sized spherical elements is between 0.4 mm and 10 mm, preferably between 0.6 mm and 1 mm.

In a variant of the invention, each of the damper cavities contains a few elements that are larger than the equally-sized elements.

A few larger elements added to the large number of small elements will stir up the small elements preventing them from packing and moving as one stiff element.

A good effect of the larger elements can be achieved if they are less than 5, preferably less than 3, in number and each have an average cross-sectional length between 1 cm and 10 cm, preferably between 2 cm and 6 cm.

In order to withstand the constant impacts from the solid elements, the damper cavities is covered on the inside with a sturdy material, such as natural rubber, artificial rubber or a mixture hereof in a preferred embodiment of the invention.

In an embodiment of the invention, the damper cavities are constructed partly from a metal such as steel, partly from natural rubber, artificial rubber or a mixture hereof to assure a sturdy device with a long lifetime.

In a preferred embodiment of the invention, damper cavities which are tuned to have maximum damping efficiency at first and second order natural frequencies relevant with modern wind turbine blades have a longest dimension between 20 cm and 80 cm, preferably between 30 cm and 50 cm.

### BRIEF DESCRIPTION OF THE DRAWINGS

An embodiment of the invention will be described in the following with reference to the figures in which

FIG. 1 illustrates a large modern wind turbine as seen from the front,

FIG. 2 illustrates a wind turbine blade comprising an oscillation damper with three closed cavities arranged near the tip of the blade to dampen edgewise oscillations of the blade,

FIG. 3 illustrates a single closed damper cavity, and

FIG. 4 is a graphical representation of the damping represented by the logarithmic decrement as a function of the amplitude of the oscillation for a damper cavity containing liquid, steel balls and a mixture of liquid and steel balls, respectively.

The figures are provided to illustrate and support the understanding of the invention and are not to be regarded as limiting of the scope of protection defined by the appended claims.

### DETAILED DESCRIPTION OF THE INVENTION

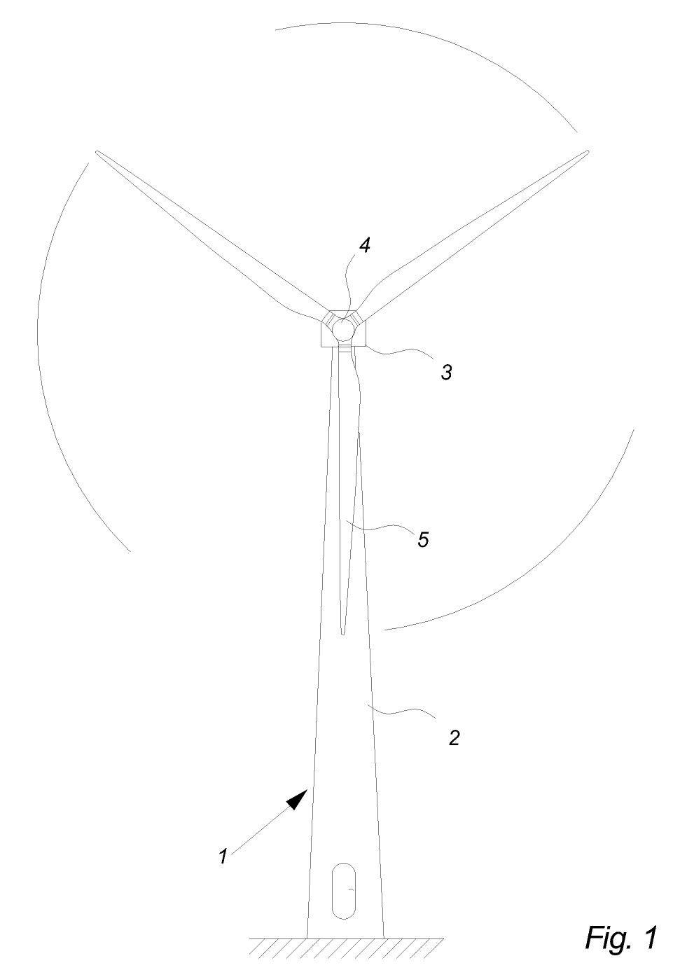

FIG. 1 illustrates a modern wind turbine 1, comprising a tower 2 and a wind turbine nacelle 3 positioned on top of the tower 2. The wind turbine rotor 4 comprising three wind turbine blades 5 is connected to the nacelle 3 through the low speed shaft which extends from the front of the nacelle 3.

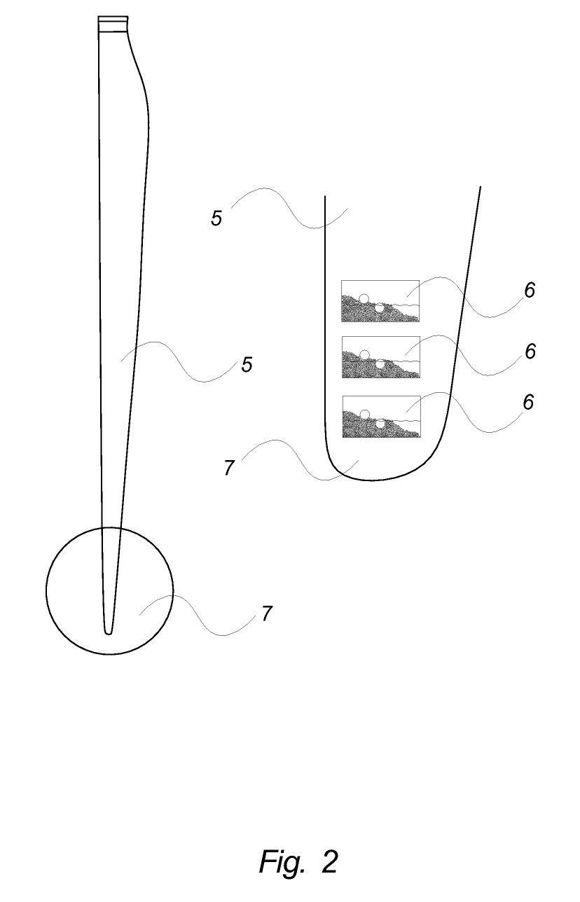

A wind turbine blade 5 comprising three closed damper cavities 6 arranged near the tip 7 of the blade to dampen edgewise oscillations of the blade 5 is illustrated in FIG. 2.

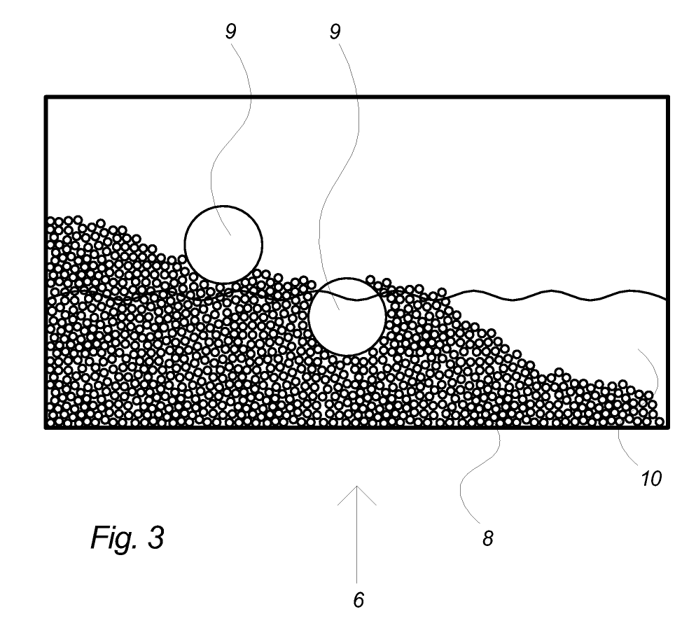

FIG. 3 illustrates a closed damper cavity 6 comprising a large number of small solid spherical elements 8, a few larger solid spherical elements 9 and a liquid 10.

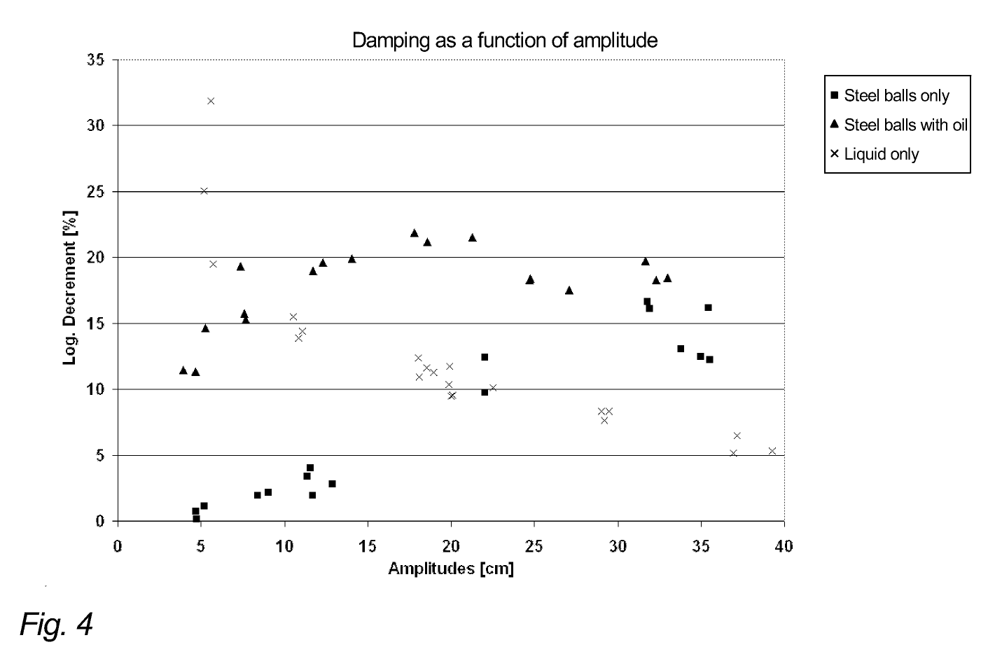

FIG. 4 is a graphical representation of the damping represented by the logarithmic decrement as a function of the amplitude of the oscillation for a damper cavity containing liquid, steel balls and a mixture of liquid and steel balls, respectively.

The values plotted in the diagram are the results from a test of three different set-ups including a liquid typically used in liquid dampers as well as a large number of small steel balls with a diameter of approximately 0.8 mm with and without oil. In each case, the damping efficiency measured by the logarithmic decrements in % was found for a number of different oscillation amplitudes. It should be noted, that the logarithmic decrements indicated on the vertical axis of the diagram corresponds to the damping of the oscillation of the steel box in the test set-up only. Thus, they do not correspond to the damping of a wind turbine part into which the damper might be arranged.

1. A wind turbine comprising one or more oscillation dampers, each damper comprising one or more closed cavities arranged within a blade of the wind turbine and containing a plurality of solid elements that are arranged to move freely within the cavities.

2. The wind turbine according to claim 1, wherein one or more of the damper cavities are arranged in an outer half of the wind turbine blade as measured from a centre of a hub towards a tip of the blade.

3. The wind turbine according to claim 1, wherein one or more of the damper cavities are arranged in a winglet mounted at a tip of the wind turbine blade.

4. The wind turbine according to claim 1, wherein the plurality of solid elements are substantially spherical.

5. The wind turbine according to claim 1, wherein a number of solid elements contained by each damper cavity is higher than 1000.

6. The wind turbine according to claim 1, wherein the solid elements are made from a material with a density larger than 3000 kg/m³.

7. The wind turbine according to claim 6, wherein said material is steel.

8. The wind turbine according to claim 1, wherein the damper cavities contain a liquid as well as the solid elements.

9. The wind turbine according to claim 8, wherein the liquid is an oil.

10. The wind turbine according to claim 8, wherein a volume of the liquid within each damper cavity is between 5% and 50% of a total volume of the solid elements within said damper cavity.

11. The wind turbine according to claim 1, wherein one or more of the oscillation dampers are designed and arranged in the wind turbine blade for damping oscillations of a first natural bending frequency of the blade in an edgewise direction with a damping of magnitude being equivalent to a logarithmic decrement of oscillation amplitudes of at least 1%.

12. The wind turbine according to claim 1, wherein one or more of the oscillation dampers are designed and arranged in the wind turbine blade for damping oscillations of a first natural bending frequency of the blade in a flapwise direction with a damping of magnitude being equivalent to a logarithmic decrement of oscillation amplitudes of at least 1%.

13. The wind turbine according to claim 1, wherein one or more of the oscillation dampers are designed and arranged in the wind turbine blade for damping oscillations of a second natural bending frequency of the blade in an edgewise direction with a damping of magnitude being equivalent to a logarithmic decrement of oscillation amplitudes of at least 1%.

14. The wind turbine according to claim 1, wherein one or more of the oscillation dampers are designed and arranged in the wind turbine blade for damping oscillations of a second natural bending frequency of the blade in a flapwise direction with a damping of magnitude being equivalent to a logarithmic decrement of oscillation amplitudes of at least 1%.

15. The wind turbine according to claim 1, wherein substantially all of the solid elements are of equal size.

16. The wind turbine according to claim 15, wherein an average cross-sectional length of each of the equally-sized solid elements is between 0.4 mm and 10 mm.

17. The wind turbine according to claim 1, wherein a majority of the solid elements are of equal size, and each of the damper cavities further contains a minority of solid elements that are larger than the majority of equally-sized solid elements.

18. The wind turbine according to claim 17, wherein a number of said larger solid elements within a given damper cavity is less than 5.

19. The wind turbine according to claim 17, wherein an average cross-sectional length of each of said larger solid elements is between 1 cm and 10 cm.

20. The wind turbine according to claim 1, wherein the damper cavities are covered on an inside with natural rubber, artificial rubber or a mixture thereof.

21. The wind turbine according to claim 1, wherein the damper cavities are constructed partly from a metal and partly from natural rubber, artificial rubber or a mixture thereof.

22. The wind turbine according to claim 1, wherein a longest dimension of each of the damper cavities is between 20 cm and 80 cm.
